(19) United States
(12) Patent Application Publication
(10) Pub. No.: US 2006/0129308 A1
(43) Pub. Date: Jun. 15, 2006

(54) Management and navigation system for the blind

(76) Inventor: Lawrence Kates, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/009,949

(22) Filed: Dec. 10, 2004

(51) Int. Cl. G01C 21/36

(52) U.S. Cl. 701/200; 701/213

(57) ABSTRACT

A computer-aided communication and navigation system that uses a computer or other processor in wireless communication with Radio Frequency Identification (RFID) tags to aid a blind person. A communication module worn by the user receives information from one or more RFID tags readers and provides audio and, optionally, stimulatory information to the blind person. In one embodiment, a tag reader is provided in a walking cane. In one embodiment, tag readers are provided in one or more ankle bracelets or shoes. In one embodiment, a wireless (or wired) earpiece is provided to provide audio information to one or both ears. In one embodiment, audio information is provided through one or more transducers that couple sound through bones. The use of bone coupling allows the blind person to hear the sound information from the communication module in concert with normal hearing. The tag readers provided to the ankles or shoes communicate with the communication module to allow the blind user to navigate by following a “trail” of RFID tags.

### BACKGROUND OF THE INVENTION

1. Field of the Invention

The present invention relates to a system for computer-aided navigation and life management system for blind people.

2. Description of the Related Art

People without the sense of sight live in a difficult world. The simple act of walking from one place to another becomes difficult and often dangerous. Walking canes and seeing-eye dogs are helpful for avoiding some obstacles, but do not solve the larger problem of navigation and situational-awareness (e.g., there is a window on the left, a table on the right, etc.). Reading signs and printed materials presents other problems. Surprisingly few blind people read Braille. So, for example, the simple act of pushing the correct elevator button for the desired floor in an unfamiliar building can be a difficult task.

### SUMMARY

These and other problems are solved by a computer-aided communication and navigation system that uses a computer or other processor in wireless communication with Radio Frequency Identification (RFID) tags to aid the blind person. An instrumented communication module receives information from one or more RFID tag readers (hereinafter tag readers) and provides audio and, optionally, stimulatory information to the blind person. In one embodiment, a tag reader is provided in a walking cane. In one embodiment, a tag reader is provided in one or more ankle bracelets. In one embodiment, a tag reader is provided in the blind person's shoes. In one embodiment, a wireless (or wired) earpiece is provided to provide audio information to one or both ears. In one embodiment, audio information is provided through one or more transducers that couple sound through bones. The use of bone coupling allows the blind person to hear the sound information from the communication module in concert with normal hearing.

In one embodiment, the communication and navigation system communicates with RFID tags located in carpeting. In one embodiment, the communication and navigation system communicates with RFID tags located along walls and/or baseboards. In one embodiment, the communication and navigation system communicates with RFID tags located along tracks in the floor. In one embodiment, the communication and navigation system communicates with RFID tags located in furniture, cabinetry, containers (e.g., pill bottles, food containers, etc.). In one embodiment, the communication and navigation system relays information from the RFID tags to a computer monitoring system.

In one embodiment, the communication and navigation system includes a computer system provided to a first wireless communication transceiver and a communication module provided to a second wireless communication transceiver. The communication module has an identification code and is configured to communicate with the computer system using two-way handshaking communication such that the computer system can send instructions to the communication module and receive acknowledgement of the instructions from the communication module. The communication module can send data to the computer system and receive acknowledgements from the computer system according to the identification code. The computer system is configured to send instructions to the communication module and to receive data from the communication module related to one or more actions of the user wearing the communication module. The computer system is configured to keep records of at least a portion of the user's actions.

In one embodiment, the communication module includes at least one of, an acoustic input device, an acoustic output device, a vibrator device, an infrared receiver, an infrared transmitter, an RFID tags reader, a GPS receiver, an inertial motion unit (e.g., accelerometers or gyroscopes), etc. In one embodiment, the communication and navigation system includes at least one of, an RF location system.

In one embodiment, the communication and navigation system includes one or more location system units disposed about an area, such as, for example, a house, barn, yard, ranch, etc. In one embodiment, the location system units use infrared radiation for location and tracking of the communication module. In one embodiment, the location system units use acoustic waves for location and tracking of the communication module. In one embodiment, the location system units use electromagnetic waves for location and tracking of the communication module. In one embodiment, the location system units are also configured to operate as motion detectors for a home security system.

In one embodiment, the communication module includes an acoustic input device. In one embodiment, the communication module includes an acoustic output device. In one embodiment, the communication module includes a vibrator device. In one embodiment, the communication module includes a keypad input device. In one embodiment, the communication module includes an infrared receiver. In one embodiment, the communication module includes an infrared transmitter. In one embodiment, the communication module includes a GPS receiver. In one embodiment, the communication module includes an inertial motion unit. In one embodiment, the communication module includes a 2-axis inertial motion unit. In one embodiment, the communication module includes a 3-axis inertial motion unit. In one embodiment, the communication module includes an accelerometer. In one embodiment, the communication module includes an RF location system. In one embodiment, the communication module includes an RFID tag reader. In one embodiment, the system includes a an RFID tag configured to provide a description of the position for the user.

In one embodiment, the system includes a video sensor. In one embodiment, the system includes a facial recognition system. In one embodiment, the system includes a video monitor. In one embodiment, the system includes one or more repeaters.

In one embodiment, the system includes one or more location system units disposed about an area. In one embodiment, one or more of the location system units are configured to use infrared radiation for location and tracking of the communication module. In one embodiment, one or more of the location system units are configured to use acoustic waves for location and tracking of the communication module. In one embodiment, one or more of the location system units are configured to use electromagnetic waves for location and tracking of the communication module.

In one embodiment, the communication device includes a cellular telephone. In one embodiment, the communication device includes a GPS receiver. In one embodiment, the communication device configured to obtain location information from one or more location RFID tags when the RFID tag reader is within range to read location information from the one or more location RFID tags, and the communication device configured to obtain location from the GPS receiver when location information is available from the GPS receiver. In one embodiment, the communication device is configured to provide waypoint information to the user. In one embodiment, the communication device is configured to provide GPS waypoint information to the user. In one embodiment, the communication device is configured to provide RFID location tag waypoint information to the user.

In one embodiment, the communication device is configured to provide RFID location tag waypoint information to the user. In one embodiment, the communication device is configured to receive waypoint information from a cellular telephone network. In one embodiment, the communication device is configured to send location information using a cellular telephone network. In one embodiment, the communication device is configured to receive building map information when the user enters a building. In one embodiment, the communication device is configured to receive local area map information.

In one embodiment, the communication device is configured to store sidewalk map information for a selected area. In one embodiment, the sidewalk map information includes locations of potentially-dangerous locations such as street intersections. In one embodiment, the sidewalk map information includes locations of potentially-dangerous locations such as driveways. In one embodiment, the sidewalk map information includes locations of potentially-dangerous locations such as steps.

In one embodiment, the communication device is configured to track movements and compute a return path for the user to return to a specified starting point.

In one embodiment, the system includes an inertial motion unit. In one embodiment, the communication device configured to use location data and data from the inertial motion unit to determine which direction the user is facing. In one embodiment, the system includes an electronic compass.

### BRIEF DESCRIPTION OF THE DRAWINGS

FIG. 1A shows a user wearing elements of a management and navigation system for the blind.

FIG. 1B shows various system elements of the communication and navigation system.

FIG. 2 shows communication between the elements of the communication and navigation system.

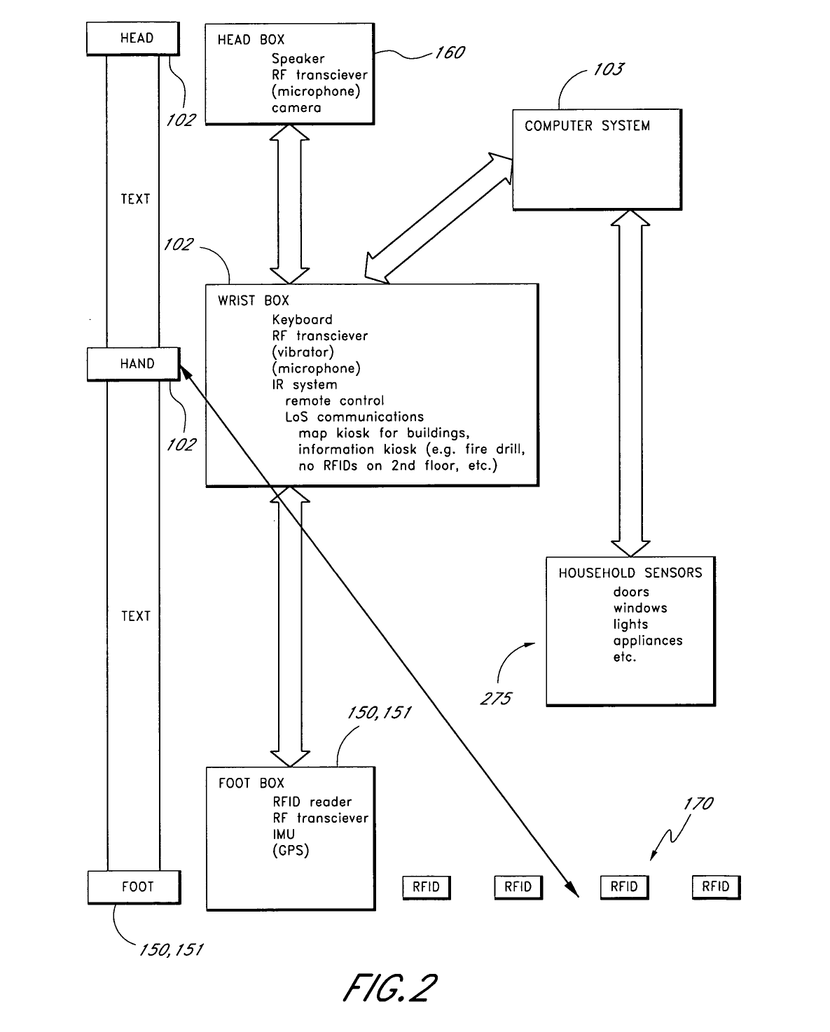

FIG. 3A is a block diagram of the communication module worn on the wrist, belt, etc.

FIG. 3B is a block diagram of the tag reader module worn on the ankles, in the shoes, etc.

FIG. 3C is a block diagram of the earpiece module worn on the ear.

FIG. 4 shows paths marked by RFID tags.

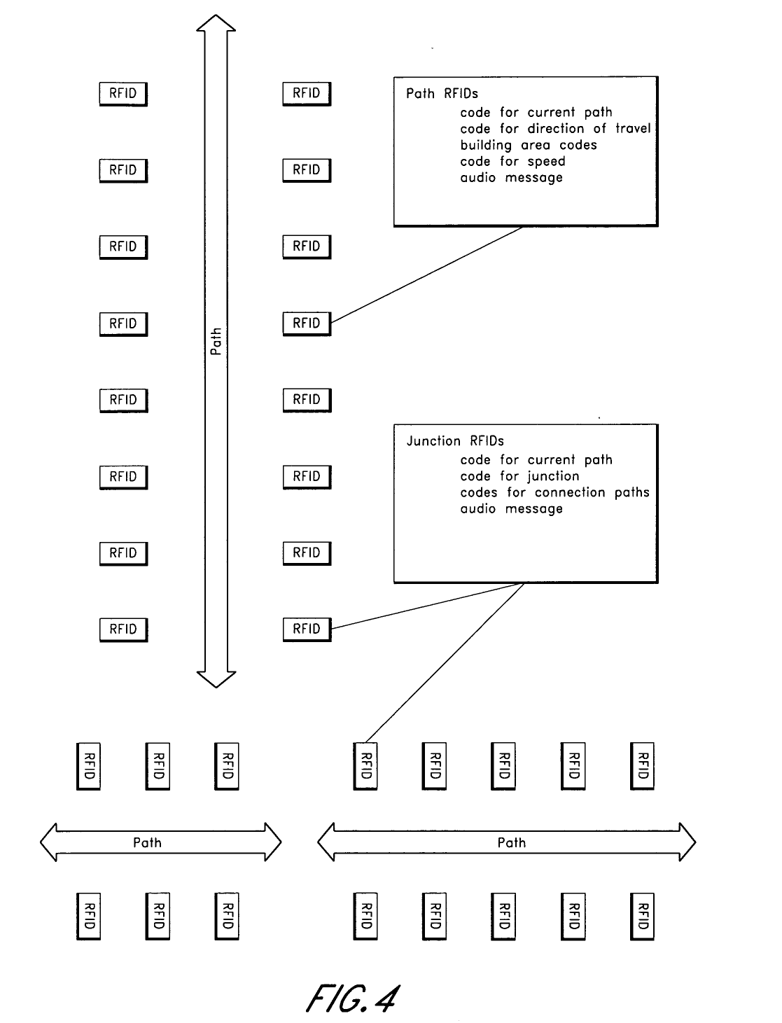

FIG. 5 shows one embodiment of a two-way path marked by RFID tags.

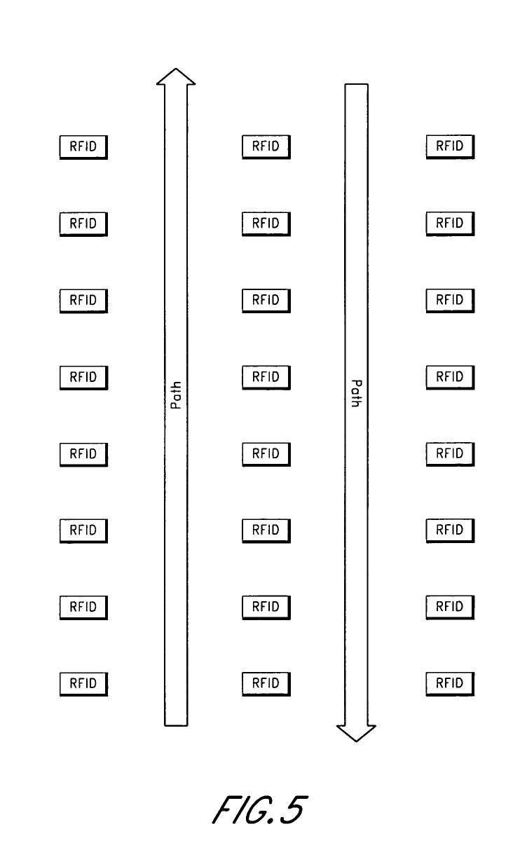

FIG. 6 shows a remote control for controlling the functions of the navigation and management system and for displaying data from the navigation and management system.

FIG. 7 is a block diagram of the remote control.

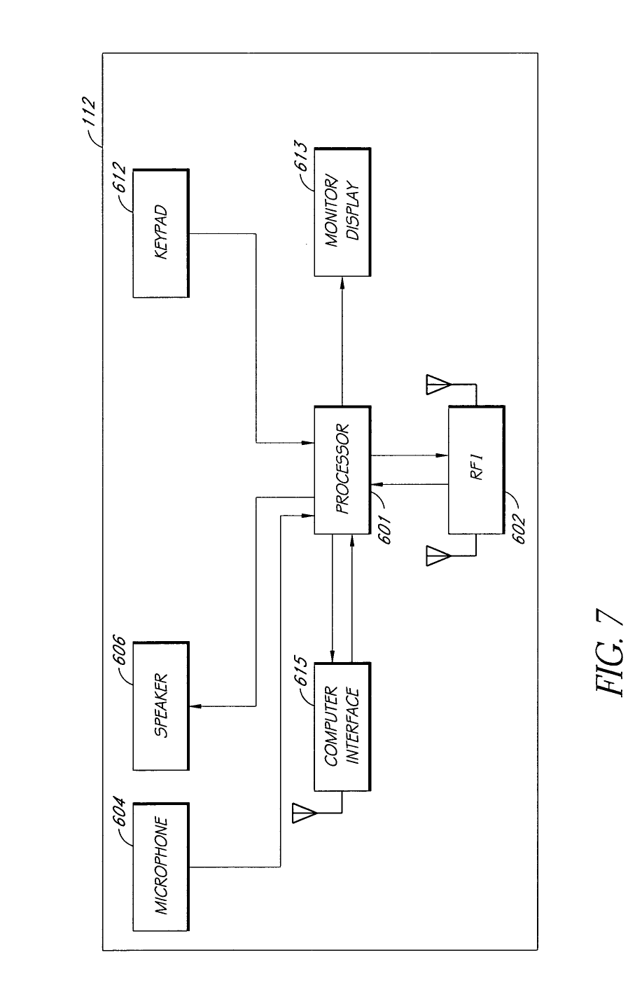

FIG. 8 is a block diagram of a repeater unit.

FIG. 9 is a block diagram of the base unit.

FIG. 10 is a architectural-type drawing of the floor plan of a portion of a house showing examples of placement of locations sensors and RFID tags to sense the movement of the user around the house.

### DETAILED DESCRIPTION

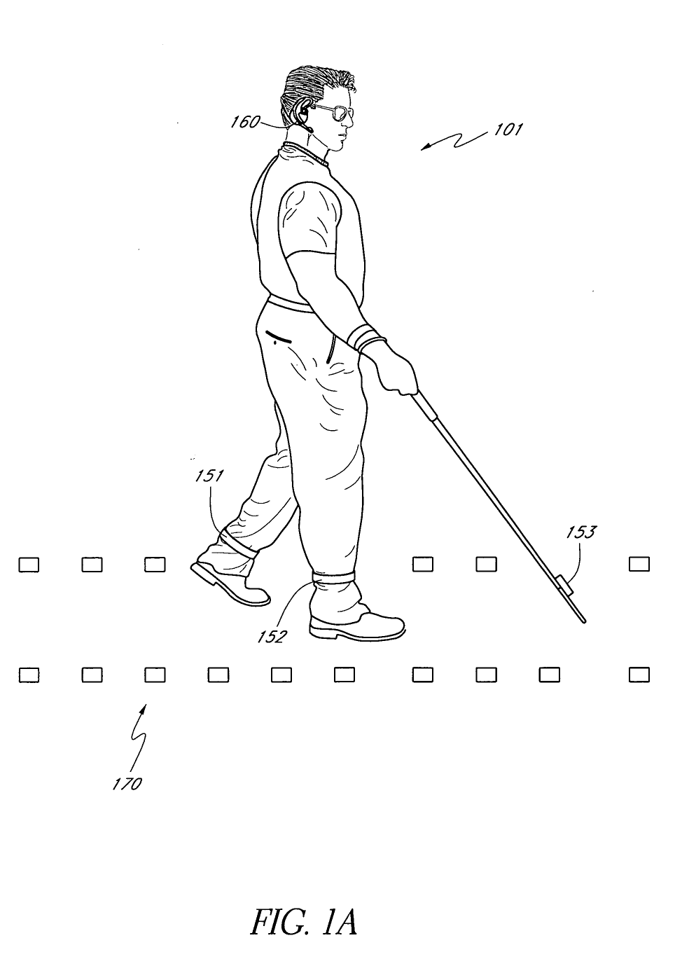

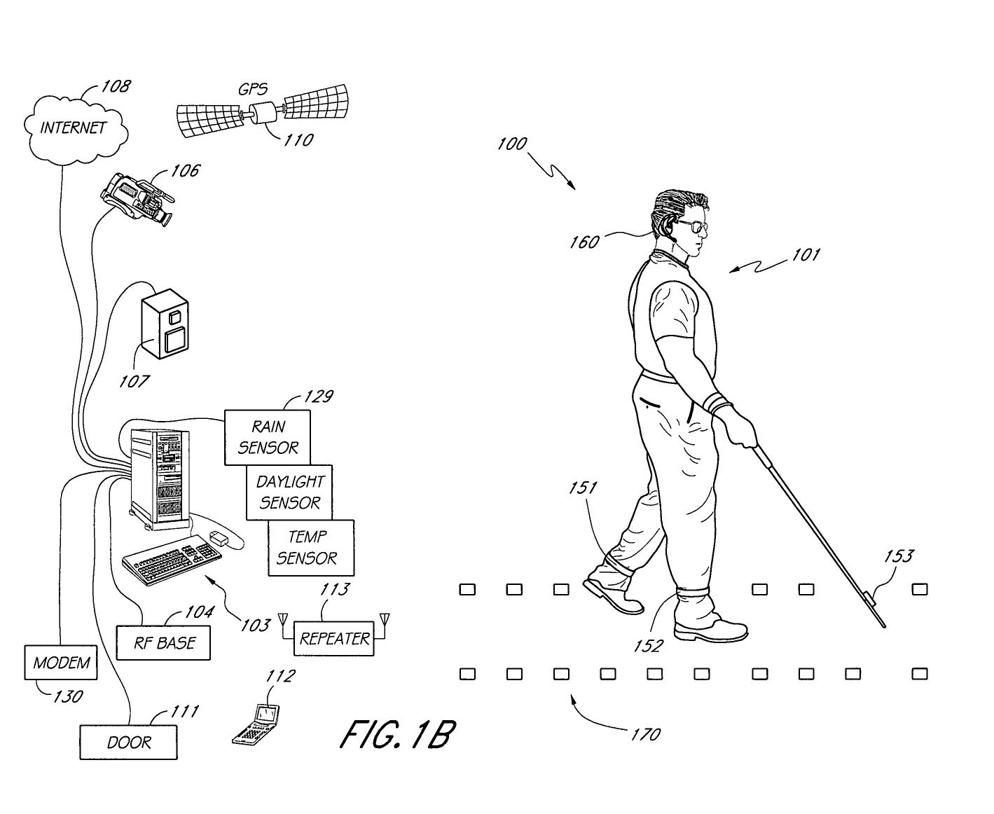

FIG. 1A shows a user 101 wearing elements of a management and navigation system for the blind. In FIG. 1A, the user 101 is shown wearing a communication module 102, ankle modules 151, 152, and a headset 160. A cane-mounted module 153 is also shown. As described below, the communication module 102, ankle modules 151, 152, and a headset 160 allow the user 101 to navigate by following a trail of RFID tags 170.

The ankle modules 151, 152 (and, optionally, the cane-mounted module 153) read the RFID tags 170 and pass the information from the RFID tags 170 to the communication module 102. The communication module 102 uses the information from the RFID modules 170 to ascertain the direction of travel, speed, and path of the user. The communication module 102 uses the headset 160 to provide audible direction and route-finding information to the user 101. The user 101 can use a microphone in the headset 160 to send voice commands to the communication module 102. The user 101 can also use buttons on a keypad on the communication module 102 to control the operation of the system and input commands into the system.

FIG. 1B shows various elements of a communication and navigation system 100 for helping a blind person 101. In the system 100, the elements shown in FIG. 1A work together with the elements shown in FIG. 1B to provide additional functionality and capability. For purposes of explanation, and not by way of limitation, the system 100 is described herein as a system to be used by a person who is blind. One of ordinary skill in the art will recognize that various aspects of the system 100 can also be used for persons that are partially blind, suffering from Alzheimer's disease, or otherwise impaired. The system 100 includes a computer system 103 and/or communication module 102 to control the system 100 and, to collect data, and to provide data for the caretaker and/or the user 101. The system typically includes a wireless communication module 102 and a wireless base unit 104. The communication module 102 communicates with one or more tag readers carried by the user 101. A tag reader 151 and a tag reader 152 can be provided in ankle bracelets or the user's shoes. In one embodiment, a tag reader 153 is provided in the tip of the user's walking cane. The base unit 104 is provided to the computer 103 and/or to the user 101 and allows the computer 103 and/or to the user 101 to communicate with the communication module 102. In one embodiment, the communication module 102 communicates with Radio Frequency ID (RFID) tags embedded in the environment. The RFID tags provides an identification code to identify location, objects, environment, etc. The communication module 102 reads the RFID tags and relays the information from the RFID tags to the computer 103 and/or to the user 101. In one embodiment, an embedded RFID tag in the user 101 includes one or more biometric sensors to allow the computer 103 and/or to the user 101 to monitor the health and condition of the user 101. In one embodiment, the embedded RFID tags includes a temperature sensor to allow the monitoring system to monitor the user's temperature. In one embodiment, the embedded RFID tag includes one or more biometric sensors to measure the user's health and well-being, such as for example, temperature, blood pressure, pulse, respiration, blood oxygenation, etc.

The system 100 can also include one or more of the following optional devices: one or more video monitors 105, one or more loudspeakers 107, one or more video cameras 106. The system 100 can further include one or more of the following optional devices: a remote control/display 112 for displaying the user's location, one or more user-controlled door controllers 111, a user-monitoring house 119, and ambient condition sensors (e.g., rain, wind, temperature, daylight, etc.) 129. In one embodiment, the ambient condition sensors are wireless sensors that communicate wirelessly with the computer system 103 and/or communication module 102.

In one embodiment, the system 100 can be used as a computerized system for training the user 101. During training, the system 100 provides navigation inputs or instructions to the user 101. Audio instructions can be provided through the loudspeakers 107, or through the audio device 160. The user tracking system described below can be used to provide corrective instructions when the user 101 is not performing correctly and/or to provide encouragement when the user 101 is performing correctly.

In one embodiment, a modem 130 is provided for making connections with the telephone system, to allow the system 100 to communicate with a caretaker and/or the user 101 through cellular telephone, text messaging, pager, etc. A network connection 108 (e.g., an Internet connection, local area network connection, wide area network connection, etc.) is provided to allow the caretaker and/or the user 101 to communicate with the system 100 and to allow the system 100 to receive updated software, updated status information, etc. Thus, for example, in one embodiment, the user 101 contact the system 103 to obtain map information, call for assistance, etc.

In one embodiment, the communication module 102 provides positive reinforcement (e.g., pleasing sounds) when the user is in a safe environment (e.g., walking in the correct direction, etc.) and/or negative reinforcement (e.g., warning sound, warning message, vibration, etc.) when the user is in an unsafe environment (e.g., walking towards a dangerous area, etc.). In one embodiment, the user 101 can select the conditions that trigger sounds versus vibrations. Thus, for example, an experienced user may choose to use vibration from the communicate module 102 for navigation communication in order to be able to hear the surrounding environment without audio distractions from the communication module 102. By contrast, a less experienced user can choose to use stereo sound inputs from the communication module 102 to help guide the user 101 to a desired location.

In one embodiment, the system 100 uses the sensors 129 to detect fire or smoke. In one embodiment, the system 100 receives alarm data from a home alarm system. In one embodiment, A microphone 304 is used to detect a fire alarm. When the system 100 detects a fire or smoke alarm, the system 100 can instruct the user to leave and notify the caretaker. The caretaker and/or the user 101 can be notified by using the loudspeakers 107, by telephone, pager, and/or text messaging using the modem 130 to connect with the telephone system, and/or by using the network connection 108 (e.g., email instant messaging, etc.). The modem 130 is configured to place a telephone call and then communicate with the user using data (e.g., in the case of text messaging) and/or synthesized voice. The modem 130 can also be used by the caretaker and/or the user 101 to contact the computer system 103 and/or communication module 102 and control the system 100 using voice recognition instructions and/or data.

In one embodiment, the system 100 uses the video cameras 106 to record videos of the user's navigation. These videos can be played back to help the caretaker and/or the user 101 understand how the navigation is progressing and to spot problems.

The user's response to instructions is monitored by the system 100 by using data from the communication module 102, and/or by video processing from one or more video cameras 106. In addition, the user's response to instructions can be determined by the caretaker and/or the user 101 in real time. In one embodiment, a caretaker or instructor works with the user 101 and the system 100 to get the user accustomed to the system.

Radio frequency identification, or RFID, is a generic term for technologies that use radio waves to automatically identify people or objects. There are several methods of identification, but the most common is to store a serial number that identifies a person or object, and perhaps other information, on a microchip that is attached to an antenna (the chip and the antenna together are called an RFID transponder or an RFID tag). The antenna enables the chip to transmit the identification information to a reader. The reader converts the radio waves reflected back from the RFID tag into digital information that can then be passed on to computers that can make use of it.

An RFID system includes a tag, which is made up of a microchip with an antenna, and an interrogator or reader with an antenna. The reader sends out electromagnetic waves. The tag antenna is tuned to receive these waves. A passive RFID tag draws power from field created by the reader and uses it to power the microchip's circuits. The chip then modulates the waves that the tag sends back to the reader and the reader converts the new waves into digital data.

Radio waves travel through most non-metallic materials, so they can be embedded in packaging or encased in protective plastic for weather-proofing and greater durability. And tags have microchips that can store a unique serial number for every product manufactured around the world.

RFID systems use many different frequencies, but generally the most common are low—(around 125 KHz), high—(13.56 MHz) and ultra-high frequency, or UHF (850-900 MHz). Microwave (2.45 GHz) is also used in some applications.

Different frequencies have different characteristics that make them more useful for different applications. For instance, low-frequency tags are cheaper than ultra high frequency (UHF) tags, use less power and are better able to penetrate non-metallic substances. They are ideal for scanning objects with high-water content, such as fruit, at close range. UHF frequencies typically offer better range and can transfer data faster. But they use more power and are less likely to pass through materials. And because they tend to be more “directed,” they require a clear path between the tag and reader.

Most countries have assigned the 125 kHz or 134 kHz area of the radio spectrum for low-frequency systems, and 13.56 MHz is used around the world for high-frequency systems. But UHF RFID systems have only been around since the mid-1990s and countries have not agreed on a single area of the UHF spectrum for RFID. Europe uses 868 MHz for UHF and the U.S. uses 915 MHz. Until recently, Japan did not allow any use of the UHF spectrum for RFID, but it is looking to open up the 960 MHz area for RFID. Many other devices use the UHF spectrum, so it will take years for all governments to agree on a single UHF band for RFID.

Active RFID tags have a battery, which is used to run the microchip's circuitry and to broadcast a signal to a reader (the way a cell phone transmits signals to a base station). Passive tags have no battery. Instead, they draw power from the reader, which sends out electromagnetic waves that induce a current in the tag's antenna. Semi-passive tags use a battery to run the chip's circuitry, but communicate by drawing power from the reader. Active and semi-passive tags are useful for tracking high-value goods that need to be scanned over long ranges, such as railway cars on a track, but they cost a dollar or more, making them too expensive to put on low-cost items. Passive UHF tags, which cost under 50 cents today in volumes of 1 million tags or more. Their read range is not as far—typically less than 20 feet vs. 100 feet or more for active tags—but they are far less expensive than active tags and can be disposed of with the product packaging.

The amount of information that can be stored on an RFID tag depends on the vendor and the application, but typically a tag can carry 2 KB of data or more.

Microchips in RFID tags can be read-write or read-only. With read-write chips, the system can add information to the tag or write over existing information when the tag is within range of a reader, or interrogator. Read-write tags usually have a serial number that cannot be written over. Additional blocks of data can be used to store additional information about the items the tag is attached to. Some read-only microchips have information stored on them during the manufacturing process. The information on such chips can never been changed. Other tags can have a serial number written to it once and then that information can't be overwritten later.

One problem encountered with RFID tags is the signal from one reader can interfere with the signal from another where coverage overlaps. This is called reader collision. One way to avoid the problem is to use a technique called time division multiple access, or TDMA. In simple terms, the readers are instructed to read at different times, rather than both trying to read at the same time.

Another problem readers have is reading a lot of chips in the same field. Tag collision occurs when more than one chip reflects back a signal at the same time, confusing the reader. Different vendors have developed different systems for having the tags respond to the reader one at a time. Since they can be read in milliseconds, it appears that all the tags are being read simultaneously.

The read range of passive tags (tags without batteries) depends on many factors: the frequency of operation, the power of the reader, interference from metal objects or other RF devices. In general, low-frequency tags are read from a foot or less. High frequency tags are read from about three feet and UHF tags are read from 10 to 20 feet. Where longer ranges are needed, such as for tracking railway cars, active tags use batteries to boost read ranges to 300 feet or more.

Software agents are applications that automate decision making by establishing a set of rules. For instance, if X happens, so does Y. They are important to RFID because humans can be overwhelmed by the amount of data coming from RFID tags and the speed at which it comes (real-time in many cases). So agents can be used to automate routine decisions and alert the user when a situation requires attention.

Most passive RFID tags simply reflect back waves from the reader. Energy harvesting is a technique in which energy from the reader is gathered by the tagged, stored momentarily and transmitted back at a different frequency. This method can improve the performance of passive RFID tags dramatically.

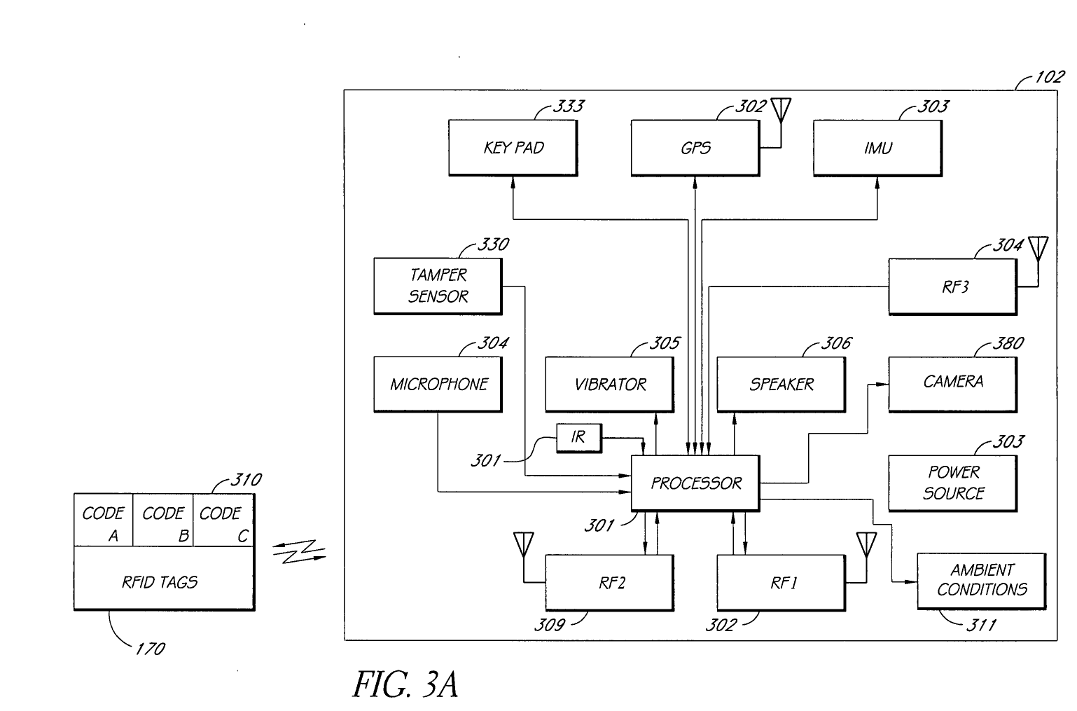

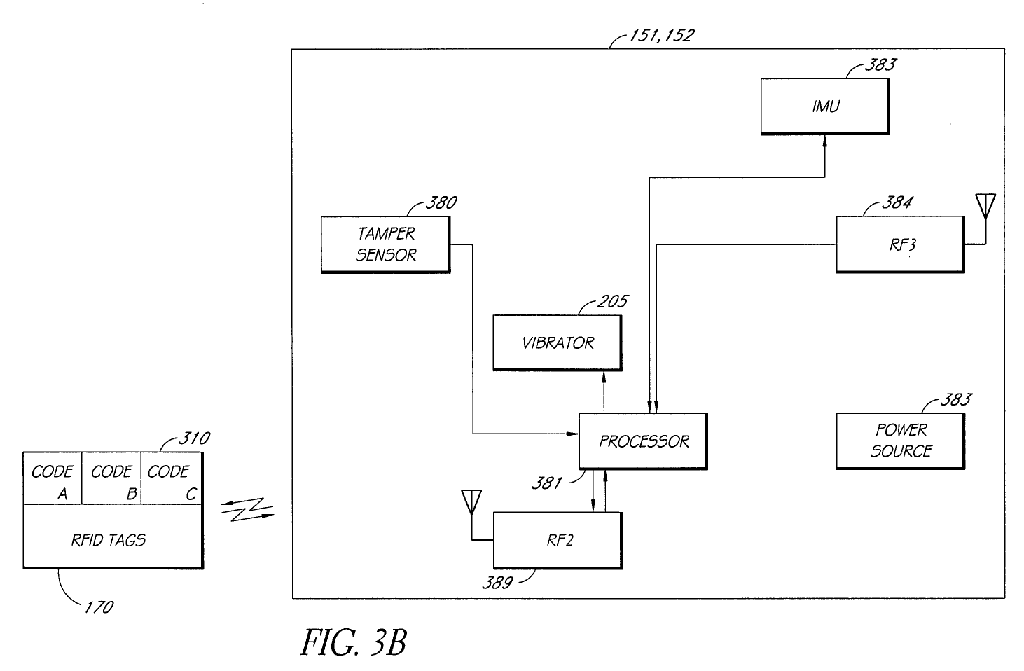

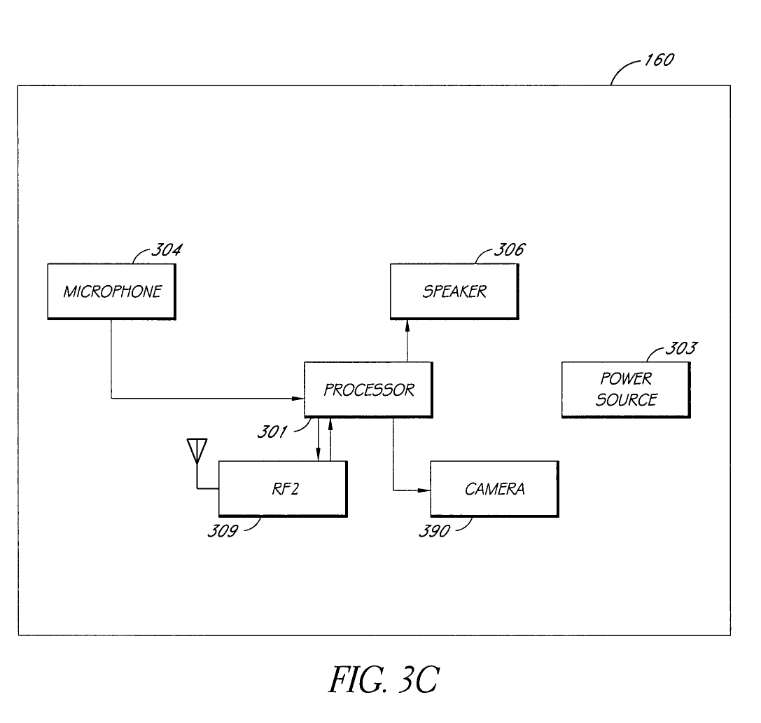

FIG. 3A is a block diagram of the communication module 102. The communication module 102 is configured to be carried and/or to be worn on the wrist, belt, chest, etc. In the communication module 102, a sound sensing device (e.g., a microphone) 304, a vibration device 305, a sound producing device (e.g., a loudspeaker) 306, and a first RF transceiver 302 are provided to a processor 301. The sound sensing device is configured to sense sound waves (sonic and/or ultrasonic) such as, for example, a microphone, a transducer, etc. For convenience, and without limitation, the sound sensing device is referred to herein as a microphone with the understanding that other acoustic transducers can be used as well. For convenience, and without limitation, the sound producing device is referred to herein as a loudspeaker with the understanding that the sound producing device is configured to produce sound waves (sonic and/or ultrasonic) such as, for example, a loudspeaker, a transducer, a buzzer, etc. A power source 303 provides power for powering the microphone 304, the vibration device 305, the loudspeaker 306 and the electric shock device 307, the first RF transceiver 302 and the processor 301. In one embodiment, each of the microphone 304, the vibration device 305, and the loudspeaker 306 are optional and can be omitted. The communication module 102 can also include a light (not shown) for providing visual indications to the instructor, or to the video cameras 106. In one embodiment, a tamper sensor 330 is also provided.

The microphone 304 is used to pick up sound waves such as, for example, sounds produced by the user 101, sounds produced by other people, and/or acoustic waves produced by an acoustic location device (sonic or ultrasonic), etc. In one embodiment, the system 100 includes facial-recognition processing to help the user 101 know who is in the room, at door, etc. The processor 301 processes the sounds picked up by the microphone and, if needed, sends processed data to the computer system 103 and/or communication module 102 for further processing. The loudspeaker 306 is used to produce pleasant and/or warning sounds for the user 101 and to provide information and instructions to the user 101. The microphone 304 and/or loudspeaker 306 can also be used in connection with an acoustic location system to locate the user using acoustic waves. In an acoustic location system, the microphone 304 and/or loudspeaker 306 communicate acoustically with acoustic sources or sensors placed about the house or yard to locate the user 101. The vibrator can be used in a manner similar to a vibrator on a cellular telephone to alert the user 101 without disturbing other people in the area. The vibrator can also be used to alert the user 101 to abnormal or potentially dangerous conditions (e.g., off course, approaching a stairwell, etc.). Blind people tend to rely more on their sense of hearing than sighted people. Thus, in one embodiment, the vibrator can be configured to provided different types of vibrations (e.g., different frequency, different intensity, different patterns, etc.) to send information to the user 101 without interfering with the user's hearing.

The optional tamper sensor 330 senses when the communication module has been tampered with (e.g., removed from the user).

The first RF transceiver 302 communicates with the base unit either directly or through the repeaters. In one embodiment, the RF transceiver 302 provides two-way communications such that the communication module 102 can send information to the computer system 103 and/or communication module 102 and receive instructions from the computer system 103 and/or communication module 102. In one embodiment, the computer system 103 and/or communication module 102 and the first RF transceiver 302 communicate using a handshake protocol, to verify that data is received. 1

FIG. 3A also shows a location finding system and a second RF transceiver 309 for communicating with one or more RFID tags. For example, RFID tags can be provided to windows, furniture, food containers, medicine containers, etc. The User 101 can use the tag reader 309 to read various RFID tags and thereby obtain information about the user's surroundings. For example, in one embodiment, an RFID tag provided to a window can include information describing how to open the window, the view outside the window, the weather outside, etc. In FIG. 3A, the communication module 102 includes one or more location and tracking systems, such as, for example, an IR system 301, a GPS location system 302, an IMU 303 and/or a third RF transceiver 304. The tracking systems can be used alone or in combination to ascertain the location of the user 101 and to help the user 101 navigate to a desired location. The IR system 301, the GPS location system 302, the IMU 303, and the third RF transceiver 304 are provided to the processor 301 and powered by the power source 303. The processor 301 controls operation of the IR system 301, the GPS location system 302, the IMU 303, and the third RF transceiver and controls when the power source delivers power to the IR system 301, the GPS location system 302 and the IMU 303. The first, second and third RF transceivers are separated in FIG. 3 for purposes of description, and not by way of limitation. In one embodiment, the first RF transceiver 302, and/or the second RF transceiver 309 and/or the third RF transceiver 304 are combined into one or more transceivers. In one embodiment, the first RF transceiver 302, and/or the second RF transceiver 309 and/or the third RF transceiver 304 operate at different frequencies.

In one embodiment, the third RF transceiver 304 is a receive-only device that receives radio location signals from one or more radio location transmitters as part of a radio location system. In an alternative embodiment, the third RF transceiver 304 is a transmit-only device that transmits radio location signals to one or more radio location receivers as part of a radio location system. In an alternative embodiment, the third RF transceiver 304 transmits radio location signals to and receives radio location signals from one or more radio location transceivers as part of a radio location system. Techniques for radio location systems such as, for example, GPS, DECCA, LORAN, etc. are known in the art. Data from the radio location system is provided to the computer system 103 and/or communication module 102 to allow the computer system 103 and/or communication module 102 to determine the location of the communication module 102. In one embodiment, radio location is provided by measuring a strength of a signal transmitted by the communication module 102 and received by one or more repeaters 113 to estimate distance between the repeaters and the communication module 102. In one embodiment, radio location is provided by measuring a strength of signals transmitted by one or more repeaters 113 and received by the communication module 102 to estimate distance between the repeaters and the communication module 102. In one embodiment, a time delay corresponding to radio frequency propagation between the repeaters 113 and the communication module 102 is used to estimate the location of the communication module 102.

FIG. 3B is a block diagram of the ankle modules 151, 152. The ankle modules 151, 152 can be worn on the ankles, built into the user's shoes, attached to the user's shoes, and/or provided to the user's walking cane. The modules 151, 152 include an RFID tag reader 389 provided to a processor 381. The tag reader 389 reads RFID tags located on the floor, or relatively low on the walls, to provide navigation information to help the user 101 navigate from place to place along the row of RFID tags 170. The processor 381 communicates with the processor via an RF transceiver 384. In one embodiment, an IMU 383 is provided to the processor 381 to provide additional information about the movement of the user's feet and/or cane. In one embodiment, a vibrator 205 is provided to the processor 381. In one embodiment, a tamper sensor 380 is provided to the processor 381.

FIG. 3C is a block diagram of the ear module 160. The module 160 include the mirophone 304, the speaker 306 and the RF transceiver 309 provided to the processor 301. The module 160 is similar in nature to a bluetooth headset for a cellular telephone in that it provides audio communication with the communication module 102. In one embodiment, the headset 160 also includes a camera 390 provided to the processor 301.

The various location systems have benefits and drawbacks. In one embodiment, the system 100 uses a combination of one or more of an RFID tag system, a GPS system, an IMU, a radio-location system, an IR system, and an acoustic system, to locate the user 101. One or more of these systems are used synergistically to locate the user 101 and the user 101 navigate to a desired location.

The IMU 303 uses one or more accelerometers and/or gyroscopes to sense motion of the communication module. The motion can be integrated to determine location. The IMU 303 provides relatively low power requirements and relatively high short-term accuracy. The IMU provides relatively lower long-term accuracy. An Inertial Motion Units (IMU) unit will work indoors or out, and typically consumes less power than other location systems. However, IMU systems are prone to drift over time and tend to lose accuracy if not recalibrated at regular intervals. In one embodiment, the IMU is recalibrated from time to time by using data from one or more of the RFID tags, GPS, acoustic, IR, and/or RF location systems. In one embodiment, the IMU 303 is used to reduce power requirements for the GPS, IR, and/or RF location systems. In one embodiment, the GPS, IR, and/or RF location systems are placed in a low-power or standby mode when the IMU 303 senses that the communication module 102 is motionless or relatively motionless. If the IMU 303 senses that the communication module 102 is relatively motionless (e.g., motionless or moving at a relatively low velocity) then the user is either not moving or is moving slowly enough that tracking is not immediately needed. In one embodiment, the IMU 303 is a 3-axis system and thus, motion of the communication module 102 in any direction is sensed as motion and can be used to activate one or more of the other sensing systems. Thus, for example, if the user has been lying down and then stands up, the “up” motion will be sensed by the IMU 303 and the communication module will activate one or more tracking systems.

In one embodiment, the system 100 assumes that the user 101 will not move at a relatively constant and relatively low velocity for any significant length of time. Thus, in one embodiment, the IMU self-calibrates to a constant offset error (e.g. a constant slope in the X, Y or Z direction) and a deviation from that constant X, Y offset error (e.g., a change in slope) is recognized as a movement by the user 101.

In one embodiment, the IMU 303 is at least a 2-axis IMU that senses motion in at least two directions. In one embodiment, the IMU 303 is at least a 3-axis IMU that senses motion in at least three directions. In one embodiment, the IMU provides data used to determine the gait of the user 101, such as, for example, running, walking, going up stairs, going down stairs, stumbling, limping, etc.

The IMU can be used alone or in combination with other tracking devices to obtain feedback on the motion of the user 101. Thus, for example, if the user 101 has indicated a desire to go to room 25 of a building, the navigation system can provide guidance information to help the user 101. In one embodiment, guidance information includes instructions (e.g., turn left, walk straight ahead 30 feet, etc.). In one embodiment, guidance information can include audio tone information reminiscent of an airplane glideslope navigation system. Thus, for example, the navigation system can play a tone in the left, ear (or couple sound into the bones of the left side of the body) if the user is veering too far left. In one embodiment, the tones become louder as the navigational error increases.

The IMU 303 can measure both dynamic acceleration as well as static acceleration forces, including acceleration due to gravity, so the IMU 303 can be used to measure tilt as well as horizontal and vertical motion. When the IMU 303 is oriented so both the X and Y axies are parallel to the earth's surface, it can be used as a two axis tilt sensor with a roll and pitch axis. Ninety degrees of roll would indicate that the user 101 is lying on its side. In addition, when the IMU 303 indicates no movement at all, regardless of the orientation of the user 101, the user 101 is asleep or inactive and the system is powered down, as described above. Thus, the IMU 303 can detect when the user is not standing.

The microphone 304 is used to allow the user to send voice commands to the system 100.

The communication module 102 sends low-battery warnings to the computer system 103 and/or communication module 102 to alert the caretaker and/or the user 101 that the communication module 102 needs fresh batteries.

The Global Positioning System (GPS) is accurate but often does not work well indoors, and sometimes does not have enough vertical accuracy to distinguish between floors of a building. GPS receivers also require a certain amount of signal processing and such processing consumes power. In a limited-power device such as the communication module 102, the power consumed by a GPS system can reduce battery life. However, GPS has the advantages of being able to operate over a large area and is thus, particularly useful when locating a user that has escaped a confined area or is out of the range of other locating systems.

GPS tends to work well outdoors, but poorly inside buildings. Thus, in one embodiment, the system 100 uses GPS in outdoor situations where RFID tags are unavailable, and RFID tags indoors where GPS is unavailable or unreliable. Thus, using the system 100, the user 101 can navigate through a first building, exit the building and walk to a second building, and then navigate through the second building. The system 100 will use different navigation systems during different portions of the user's journey.

In one embodiment, a building includes data port near the entrance that provides navigation information to the system 102 regarding the map of the building. When the user 101 enters the building, the system 102 obtains the building map information from the data port so that the user can navigate through the building. In one embodiment, the map information provided by the data port includes dynamic information, such as, for example, construction areas, restrooms closed for cleaning, etc.

In one embodiment, the GPS system 302 operates in a standby mode and activates at regular intervals or when instructed to activate. The GPS system can be instructed by the computer 103 and/or to the user 101 or the communication module to activate. When activated, the GPS system obtains a position fix on the user 101 (if GPS satellite signals are available) and updates the IMU. In one embodiment, a GPS system is also provided to the computer system 103 and/or communication module 102. The computer system uses data from its GPS system to send location and/or timing data to the GPS system 302 in the communication module 102 allowing the GPS system 302 to warm start faster, obtain a fix more quickly, and therefore, use less power.

In one embodiment, location system units 118 are placed about a house or building to locate movement and location of the user 101. In one embodiment, location system units 118 send infrared light, acoustic waves, and/or electromagnetic waves to one or more sensors on the communication module 102 in order to conserve power in the communication module 102. In one embodiment, the communication module 102 sends infrared light, acoustic waves, and/or electromagnetic waves to the location system units 118 in order to conserve power in the units 118.

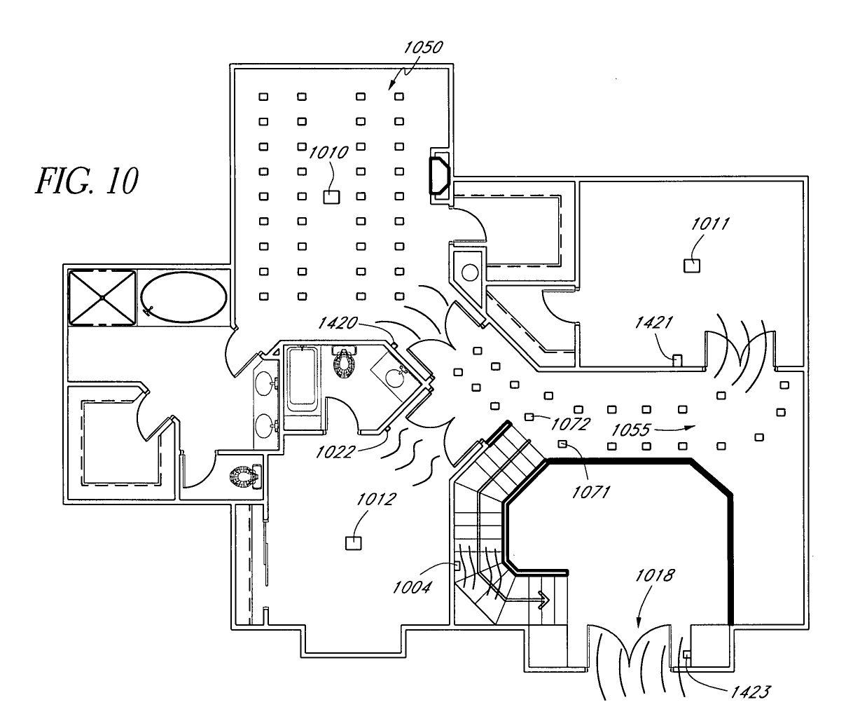

For example, location system units 118 placed near doorways or in hallways (see e.g., FIG. 10) can be used to determine when the user 101 moves from one room to another. Even if the user cannot be exactly located within the room (e.g., due to blind spots), a location system unit 118 placed to sense the movement of the user though the doorway allows the system 100 to know which room the user is in by watching the user 101 move from room to room.

In one embodiment, each location transmitter (whether in the communication module 102 or the location system units 118) sends a coded pattern of pulses to allow the transmitter to be identified. In one embodiment, in order to conserve power, the location receiver (whether in the communication module 102 or the location system units 118) notifies the computer system 103 and/or communication module 102 whenever the pattern of received pulses changes. Thus, for example, when the location receiver enters the range of a first location transmitter that transmits a first code, the location receiver sends a “location sensor message” to the computer system 103 and/or communication module 102. In one embodiment, the location receiver does not send further location sensor messages so long as the location receiver continues to receive the pattern of pulses from the same location transmitter. In an alternate embodiment, the location receiver sends location sensor messages to the computer system 103 and/or communication module 102 on a periodic basis so long as the location receiver continues to receive the pattern of pulses from the same transmitter. The location receiver sends a “location sensor lost” message when the pattern of pulses stops.

Motion detectors inside and/or outside a house are commonly provided in connection with home security systems. In one embodiment, the location system units 118 are configured as motion detectors, and the IR system 301 (e.g., transmitter and/or receiver) on the communication module 102 communicates with such IR motion detectors to avoid false alarms that would otherwise occur when the motion detector detects the movement of the user. In one embodiment, the communication module transmits an IR signal that the motion detector recognizes as coming from the communication module 102 and thus, the motion detector knows that the motion it is sensing is due to the user and not an intruder. In one embodiment, when the communication module 102 detects an IR transmission from a motion detector, the communication module transmits a response IR signal that the motion detector recognizes. In one embodiment, the IR tracking system used by the system 100 is also used as part of a home security system to track both the movement of the user and other movements in the house that are not due to the user. Acoustic motion detectors and/or microwave motion detectors can be used with the communication module 102 similarly to the IR motion detectors.

Unlike VHF radio-based systems (e.g., GPS or VHF radio-location systems, etc.), IR, acoustic, and/or millimeter wave and some microwave systems do not penetrate walls very effectively. Thus, an IR, acoustic, and/or microwave/millimeter wave system can be used in the system 100 to locate the user 101 without having a map of the house or building. Radio-based systems that operate at frequencies that penetrate walls can be used in connection with a map of the house

In one embodiment, the IR system is replaced or augmented by a sonic or ultrasonic system. In one embodiment, the operation of the sonic or ultrasonic system is similar to that of the IR system except that the waves are sound waves instead of infrared waves.

In one embodiment, the sonic or ultrasonic system includes a ranging function similar to that of an RF system. In one embodiment, the ranging function uses a two-frequency phase comparison system to measure distance from the sound transmitter to the sound receiver.

In one embodiment, the IR system 301 can be used to send IR signals to the video cameras 106.

In one embodiment, the system 100 locates the user periodically (e.g., communicates with the communication module 102) and alerts the caretaker and/or the user 101 if the user cannot be found (e.g., if the system 100 cannot contact the communication module 102). In one embodiment, the system 100 locates the user and alerts the caretaker and/or the user 101 if the user has escaped or is in an area that is dangerous to the user (e.g., near a pool, cliff, etc.).

In one embodiment, the system 100 can be used to communicate with the user. The system 100 receives feedback regarding the user's movements, actions, and environments, and can thus, learn various aspects of the user's behavior and vocabulary. In one embodiment, the system 100 is configured to recognize sounds made by the user (e.g., commands) the microphone in the communication module 102 and the signal processing capabilities in the communication module 102 and in the processor 130. This user “speech recognition” system can base its discrimination on acoustic features, such as, for example, formant structure, pitch, loudness, spectral analysis, etc. When the computer recognizes the message behind the sounds made by the user, then the system 130 can respond accordingly, either by providing a message to the caretaker and/or the user 101 or by taking action in the user's environment. Thus, for example, the user 101 can query the system 100 as to the outside temperature, set the home thermostat, turn lights on and off, etc. In one embodiment, the system 130 is provided with communications access (e.g., Internet access, cellular telephone access, pager access, etc.) to contact the caretaker. In an alternate example, if the user makes a sound indicating that help is needed, then the system 130 can contact a caretaker or emergency service.

In one embodiment, the system 100 recognizes the speech of user 101 and thus, if a stranger or unknown person enters the area and makes sounds, the system 100 can recognize that a stranger or unknown person is in the area and take appropriate action (e.g., notify the caretaker, emergency service, security service, etc.)

In one embodiment, the system 100 uses the sensors 129 to monitor ambient conditions such as, for example, indoor temperature, outdoor temperature, rain, humidity, precipitation, daylight, etc. and uses the information to look after the users well being. Using the daylight sensor and/or time of day available from the computer 103 and/or to the user 101, the system 100 can be used to help the user 101 understand whether it is light or dark outside, morning or evening, raining, cloudy, etc

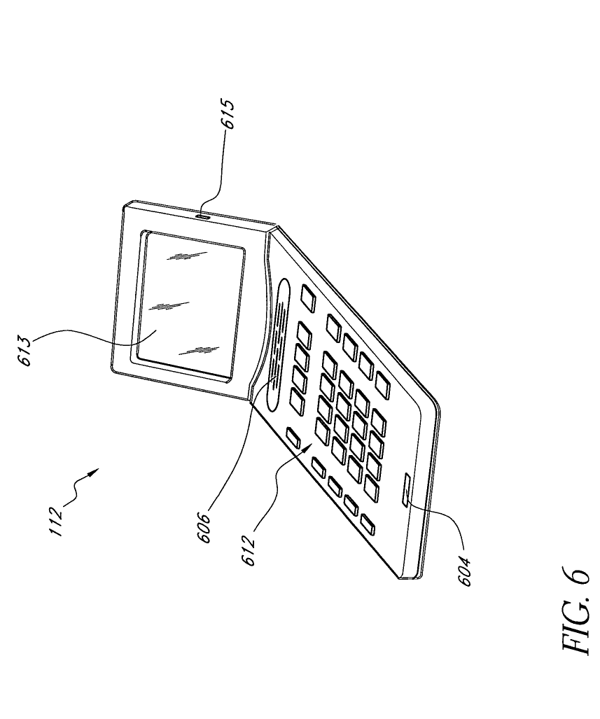

FIG. 6 is a block diagram of the remote control 112 for controlling the system 100 and for receiving information from the system 100. The remote control 112 includes a microphone 604, a loudspeaker 606, a keyboard (or keypad) 612, a display 613, and a first RF transceiver 602, all provided to a processor 601.

The remote control 112 communicates with the computer system 103 and/or communication module 102 using the RF transceiver 602 to receive status information and to send instructions to the system 100. Using the remote control 112, the caretaker can check on the location, health, and status of the user 101. The caretaker and/or the user 101 can also use the remote control 112 to send instructions to the system 100 and to the user 101. For, example, using the microphone 604, the caretaker can speak to the user 101. In one embodiment, the computer system 103 and/or communication module 102 sends display information to the display 613 to show the location of the user 101. If the location of the user cannot be ascertained, the system 100 can send a “user not found” message and attempt to contact the caretaker and/or the user 101 using the network connection 108, the modem 130, and/or the remote control 112. If the system 100 determines that the user has escaped, the system 100 can send a “user lost” message and attempt to contact the caretaker and/or the user 101 using the network connection 108, the modem 130, and/or the remote control 112.

Each of the wireless units of the system 100 includes a wireless communication transceiver 302 for communication with the base unit 104 (or repeater 113). Thus, the discussion that follows generally refers to the communication module 102 as an example, and not by way of limitation. Similarly, the discussion below generally refers to the base unit 104 by way of example, and not limitation. It will also be understood by one of ordinary skill in the art that repeaters 113 are useful for extending the range of the communication module 102 but are not required in all configurations.

When the communication module 102 detects a reportable condition the communication module 102 communicates with the repeater unit 113 and provides data regarding the occurrence. The repeater unit 113 forwards the data to the base unit 104, and the base unit 104 forwards the information to the computer 103 and/or to the user 101. The computer 103 and/or to the user 101 evaluates the data and takes appropriate action. If the computer 103 and/or to the user 101 determines that the condition is an emergency, then the computer 103 and/or to the user 101 contacts the caretaker through telephone communication, Internet, the remote 112, the monitor 108, the computer monitor, etc. If the computer 103 and/or to the user 101 determines that the situation warrants reporting, but is not an emergency, then the computer 103 and/or to the user 101 logs the data for later reporting to the caretaker and/or the user 101 when the caretaker and/or the user 101 requests a status report from the computer 103 and/or to the user 101.

In one embodiment, the communication module 102 has an internal power source (e.g., battery, solar cell, fuel cell, etc.). In order to conserve power, the communication module 102 is normally placed in a low-power mode. In one embodiment, using sensors that require relatively little power, while in the low power mode the communication module 102 takes regular sensor readings and evaluates the readings to determine if a condition exists that requires data to be transmitted to the central computer 103 and/or to the user 101 (hereinafter referred to as an anomalous condition). In one embodiment, using sensors that require relatively more power, while in the low power mode the communication module 102 takes and evaluates sensor readings at periodic intervals. Such sensor readings can include, for example, sound samples from the microphone 304, location readings from the location sensors 301, 302, 303, and/or 304, the RFID tags 170, etc.) If an anomalous condition is detected, then the communication module 102 “wakes up” and begins communicating with the base unit 104 through the repeater 113. At programmed intervals, the communication module 102 also “wakes up” and sends status information (e.g., power levels, self diagnostic information, etc.) to the base unit 104 and then listens for instructions for a period of time. In one embodiment, the communication module 102 also includes a tamper detector. When tampering with the communication module 102 is detected (e.g., someone has removed the communication module 102 or the user has somehow gotten out of the communication module 102, etc.), the communication module 102 reports such tampering to the base unit 104.

In one embodiment, the communication module 102 provides bi-directional communication and is configured to receive data and/or instructions from the base unit 104. Thus, for example, the base unit 104 can instruct the communication module 102 to perform additional measurements, to go to a standby mode, to wake up, to report battery status, to change wake-up interval, to run self-diagnostics and report results, etc. In one embodiment, the communication module 102 reports its general health and status on a regular basis (e.g., results of self-diagnostics, battery health, etc.).

In one embodiment, the communication module 102 samples, digitizes, and stores audio data from the microphone 304 when such data exceeds a volume threshold and/or when other sensors indicate that the audio data should be digitized and stored. For example, when sending voice commands, the user 101 can press a button on the keypad 333 to indicate that a voice command is being given. The user 101 can also use the keypad 333 to enter commands to the communication module 101.

In one embodiment, the communication module 102 provides two wake-up modes, a first wake-up mode for taking sensor measurements (and reporting such measurements if deemed necessary), and a second wake-up mode for listening for instructions from the central computer 103 and/or to the user 101. The two wake-up modes, or combinations thereof, can occur at different intervals.

In one embodiment, the communication module 102 use spread-spectrum techniques to communicate with the repeater unit 113. In one embodiment, the communication module 102 uses Code Division Multiple Access (CDMA) techniques. In one embodiment, the communication module 102 uses frequency-hopping spread-spectrum. In one embodiment, the communication module 102 has an address or identification (ID) code that distinguishes the communication module 102 from the other RF units of the system 100. The communication module 102 attaches its ID to outgoing communication packets so that transmissions from the communication module 102 can be identified by the repeater 113. The repeater 113 attaches the ID of the communication module 102 to data and/or instructions that are transmitted to the communication module 102. In one embodiment, the communication module 102 ignores data and/or instructions that are addressed to other RF units.

In one embodiment, the communication module 102 includes a reset function. In one embodiment, the reset function is activated by a reset switch on the communication module 102. In one embodiment, the reset function is activated when power is applied to the communication module 102. In one embodiment, the reset function is activated when the communication module 102 is connected to the computer system 103 and/or communication module 102 by a wired connection for programming. In one embodiment, the reset function is active for a prescribed interval of time. During the reset interval, the transceiver 302 is in a receiving mode and can receive the identification code from the computer 103 and/or to the user 101. In one embodiment, the computer 103 and/or user 101 wirelessly transmits a desired identification code. In one embodiment, the identification code is programmed by connecting the communication module 102 to the computer through an electrical connector, such as, for example, a USB connection, a firewire connection, etc. In one embodiment, the electrical connection to the communication module 102 is provided by sending modulated control signals (power line carrier signals) through a connector used to connect the power source 303. In one embodiment, the external programmer provides power and control signals.

In one embodiment, the communication module 102 communicates with the repeater 113 on the 900 MHz band. This band provides good transmission through walls and other obstacles normally found in and around a building structure. In one embodiment, the communication module 102 communicates with the repeater 113 on bands above and/or below the 900 MHz band. In one embodiment, the communication module 102, repeater 113, and/or base unit 104 listens to a radio frequency channel before transmitting on that channel or before beginning transmission. If the channel is in use, (e.g., by another device such as another repeater, a cordless telephone, etc.) then the sensor, repeater, and/or base unit changes to a different channel. In one embodiment, the communication module 102, repeater, and/or base unit coordinate frequency hopping by listening to radio frequency channels for interference and using an algorithm to select a next channel for transmission that avoids the interference. Thus, for example, in one embodiment, if the communication module 102 senses a dangerous condition (e.g., the user 101 is choking or crying in pain) and goes into a continuous transmission mode, the communication module 102 tests (e.g., listens to) the channel before transmission to avoid channels that are blocked, in use, or jammed. In one embodiment, the communication module 102 continues to transmit data until it receives an acknowledgement from the base unit 104 that the message has been received. In one embodiment, the communication module transmits data having a normal priority (e.g., status information) and does not look for an acknowledgement, and the communication module transmits data having elevated priority until an acknowledgement is received.

The repeater unit 113 is configured to relay communications traffic between the communication module 102 and the base unit 104. The repeater unit 113 typically operates in an environment with several other repeater units. In one embodiment, the repeater 113 has an internal power source (e.g., battery, solar cell, fuel cell, etc.). In one embodiment, the repeater 113 is provided to household electric power. In one embodiment, the repeater unit 113 goes to a low-power mode when it is not transmitting or expecting to transmit. In one embodiment, the repeater 113 uses spread-spectrum techniques to communicate with the base unit 104 and with the communication module 102. In one embodiment, the repeater 113 uses frequency-hopping spread-spectrum to communicate with the base unit 104 and the communication module 102. In one embodiment, the repeater unit 113 has an address or identification (ID) code and the repeater unit 113 attaches its address to outgoing communication packets that originate in the repeater (that is, packets that are not being forwarded).

In one embodiment, the base unit 104 communicates with the communication module 102 by transmitting a communication packet addressed to the communication module unit 102. The repeaters 113 receive the communication packet addressed to the communication module unit 102. The repeaters 113 transmit the communication packet addressed to the communication module 102 to the communication module unit 102. In one embodiment, the communication module unit 102, the repeater units 113, and the base unit 104 communicate using Frequency-Hopping Spread Spectrum (FHSS), also known as channel-hopping.

Frequency-hopping wireless systems offer the advantages of avoiding other interfering signals and avoiding collisions. Moreover, there are regulatory advantages given to systems that do not transmit continuously at one frequency. Channel-hopping transmitters change frequencies after a period of continuous transmission, or when interference is encountered. These systems may have higher transmit power and relaxed limitations on in-band spurs. FCC regulations limit transmission time on one channel to 1200 milliseconds (averaged over a period of time 10-20 seconds depending on channel bandwidth) before the transmitter must change frequency. There is a minimum frequency step when changing channels to resume transmission.

In one embodiment, the communication module unit 102, the repeater unit 110, and the base unit 104 communicate using FHSS wherein the frequency hopping of the communication module unit 102, the repeater unit 110, and the base unit 104 are not synchronized such that at any given moment, the communication module 102 and the repeater unit 113 are on different channels. In such a system, the base unit 104 communicates with the communication module 102 using the hop frequencies synchronized to the repeater unit 113 rather than the communication module unit 102. The repeater unit 113 then forwards the data to the communication module unit using hop frequencies synchronized to the communication module unit 102. Such a system largely avoids collisions between the transmissions by the base unit 104 and the repeater unit 110.

In one embodiment, the RF units 102, 114-122 use FHSS and are not synchronized. Thus, at any given moment, it is unlikely that any two or more of the units 102, 114-122 will transmit on the same frequency. In this manner, collisions are largely avoided. In one embodiment, collisions are not detected but are tolerated by the system 100. If a collision does occur, data lost due to the collision is effectively re-transmitted the next time the communication module units transmit communication module data. When the units 102, 114-122 and repeater units 113 operate in asynchronous mode, then a second collision is highly unlikely because the units causing the collisions have hopped to different channels. In one embodiment, the unit 102, 114-122, repeater units 113, and the base unit 104 use the same hop rate. In one embodiment, the units 102, 114-122, repeater units 113, and the base unit 104 use the same pseudo-random algorithm to control channel hopping, but with different starting speeds. In one embodiment, the starting speed for the hop algorithm is calculated from the ID of the units 102, 114-122, repeater units 113, or the base unit 104.

In an alternative embodiment, the base unit 104 communicates with the communication module 102 by sending a communication packet addressed to the repeater unit 113, where the packet sent to the repeater unit 113 includes the address of the communication module unit 102. The repeater unit 113 extracts the address of the communication module 102 from the packet and creates and transmits a packet addressed to the communication module unit 102.

In one embodiment, the repeater unit 113 is configured to provide bi-directional communication between the communication module 102 and the base unit 104. In one embodiment, the repeater 113 is configured to receive instructions from the base unit 104. Thus, for example, the base unit 104 can instruct the repeater to: send instructions to the communication module 102; go to standby mode; “wake up”; report power status; change wake-up interval; run self-diagnostics and report results; etc.

The base unit 104 is configured to receive measured communication module data from a number of RF units either directly, or through the repeaters 113. The base unit 104 also sends instructions to the repeater units 113 and/or to the communication module 102. When the base unit 104 receives data from the communication module 102 indicating that there may be an emergency condition (e.g., the user is in distress) the computer 103 and/or to the user 101 will attempt to notify the caretaker and/or the user 101.

In one embodiment, the computer 104 maintains a database of the health, power status (e.g., battery charge), and current operating status of all of the RF units 102, 114-122 and the repeater units 113. In one embodiment, the computer 103 and/or to the user 101 automatically performs routine maintenance by sending instructions to each unit 102, 114-122 to run a self-diagnostic and report the results. The computer 103 and/or to the user 101 collects and logs such diagnostic results. In one embodiment, the computer 103 and/or to the user 101 sends instructions to each RF unit 102, 114-122 telling the unit how long to wait between “wakeup” intervals. In one embodiment, the computer 103 and/or to the user 101 schedules different wakeup intervals to different RF units based on the unit's health, power status, location, usage, etc. In one embodiment, the computer 103 and/or to the user 101 schedules different wakeup intervals to different communication module units based on the type of data and urgency of the data collected by the unit (e.g., the communication module 102 has higher priority than the water unit 120 and should be checked relatively more often). In one embodiment, the base unit 104 sends instructions to repeaters 113 to route communication module information around a failed repeater 113.

In one embodiment, the computer 103 and/or to the user 101 produces a display that tells the caretaker and/or the user 101 which RF units need repair or maintenance. In one embodiment, the computer 103 and/or to the user 101 maintains a list showing the status and/or location of each user 101 according to the ID of each communication module. In one embodiment, the ID of the communication module 102 is obtained from the RFID chip embedded in the user 101. In one embodiment, the ID of the communication module 102 is programmed into the communication module by the computer system 103 and/or communication module 102. In one embodiment, the ID of the communication module 102 is programmed into the communication module at the factory such that each communication module has a unique ID.

In one embodiment, the communication module 102 and/or the repeater units 113 measure the signal strength of the wireless signals received (e.g., the communication module 102 measures the signal strength of the signals received from the repeater unit 113, the repeater unit 113 measures the signal strength received from the communication module 102 and/or the base unit 104). The communication module unit 102 and/or the repeater units 113 report such signal strength measurement back to the computer 103 and/or to the user 101. The computer 103 and/or to the user 101 evaluates the signal strength measurements to ascertain the health and robustness of the RF units of the system 100. In one embodiment, the computer 103 and/or to the user 101 uses the signal strength information to re-route wireless communications traffic in the system 100. Thus, for example, if the repeater unit 113 goes offline or is having difficulty communicating with the communication module unit 102, the computer 103 and/or to the user 101 can send instructions to a different repeater unit

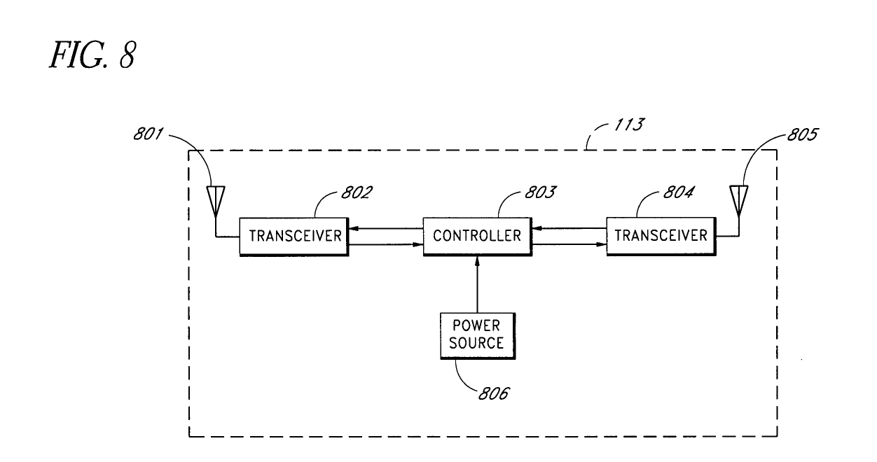

FIG. 8 is a block diagram of the repeater unit 113. In the repeater unit 113, a first transceiver 802 and a second transceiver 804 are provided to a controller 803. The controller 803 typically provides power, data, and control information to the transceivers 802, 804. A power source 806 is provided to the controller 803.

When relaying communication module data to the base unit 104, the controller 803 receives data from the first transceiver 802 and provides the data to the second transceiver 804. When relaying instructions from the base unit 104 to a communication module unit, the controller 803 receives data from the second transceiver 804 and provides the data to the first transceiver 802. In one embodiment, the controller 803 conserves power by placing the transceivers 802, 804 in a low-power mode during periods when the controller 803 is not expecting data. The controller 803 also monitors the power source 806 and provides status information, such as, for example, self-diagnostic information and/or information about the health of the power source 806, to the base unit 104. In one embodiment, the controller 803 sends status information to the base unit 104 at regular intervals. In one embodiment, the controller 803 sends status information to the base unit 104 when requested by the base unit 104. In one embodiment, the controller 803 sends status information to the base unit 104 when a fault condition (e.g., battery low, power failure, etc.) is detected.

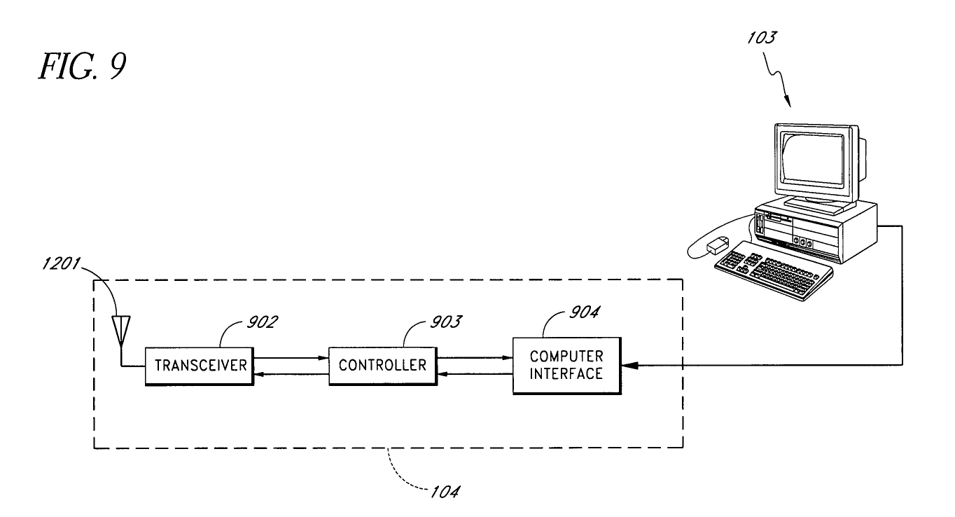

FIG. 9 is a block diagram of the base unit 104. In the base unit 104, a transceiver 902 and a computer interface 904 are provided to a controller 903. The controller 903 typically provides data and control information to the transceivers 902 and to the interface. The interface 904 is provided to a port on the monitoring computer 103 and/or to the user 101. The interface 904 can be a standard computer data interface, such as, for example, Ethernet, wireless Ethernet, firewire port, Universal Serial Bus (USB) port, bluetooth, etc.

In one embodiment, the caretaker and/or user selects the age and experience level of the user 101 from a list of provided by the computer 103. The computer 103 and/or to the user 101 adjusts the instructional environment based on the user's experience.

In one embodiment, a remote instructor can use the Internet or telephone modem to connect to the computer system 103 and/or communication module 102 and remotely train the user or provide other interaction with the user.

FIG. 10 is a architectural-type drawing of the floor plan of a portion of a house showing examples of placement of locations sensors to sense the movement of the user around the house. In FIG. 10, relatively short-range sensors are placed in doorways or key passageways (e.g., halls, stairs, etc.) to track the general movement of the user through the house. Location system units 1020-1423 are placed in or near doorways, and a location system unit 1024 is placed in a stairway.

In one embodiment, the location system units 1020-1424 or 1010-1412 are (or include) infrared sensors that communicate with the infrared system 301 in the communication module 102 to provide relatively short-range relatively line-of sight communication for tracking the movements of the user. As the user passes the location system units 1020-1424 or 1010-1412, the sensor communicates with the communication module 102 to note the passage of the user and the information is then transmitted back to the computer 103 and/or to the user 101 either by the communication module 102 or the location system units 1020-1424 or 1010-1412. In one embodiment, the location system units 1020-1424 or 1010-1412 also operate as motion detectors for a home security system.

In one embodiment, the location system units 1020-1424 or 1010-1412 are (or include) acoustic sensors that communicate with the acoustic systems in the communication module 102 to provide relatively short-range relatively line-of sight communication for tracking the movements of the user. As the user passes the location system units 1020-1424 or 1010-1412, the sensor communicates with the communication module 102 to note the passage of the user and the information is then transmitted back to the computer 103 and/or to the user 101 either by the communication module 102 or the location system units 1020-1424 or 1010-1412. In one embodiment, the location system units 1020-1424 or 1010-1412 also operate as motion detectors for a home security system.

In one embodiment, the location system units 1020-1424 or 1010-1412 are (or include) relatively low-power microwave transmitters or receivers that communicate with the RF system 304 in the communication module 102 to provide relatively short-range relatively line-of sight communication for tracking the movements of the user. As the user passes the location system units 1020-1424 or 1010-1412, the sensor communicates with the communication module 102 to note the passage of the user and the information is then transmitted back to the computer 103 and/or to the user 101 either by the communication module 102 or the location system units 1020-1424 or 1010-1412.

In one embodiment, RFID tags 1050 are provided by a carpet on a defined grid, such that laying the carpet creates a grid of RFID tags in the area. In one embodiment, the RFID tags 1050 are provided in connection with a carpet underlayment.

In one embodiment, the computer system 103 and/or communication module 102 is provided with a map of the house and shows the location of the user with respect to the map.

In one embodiment one or more of the radio frequency aspects of the system 100 use a frequency band between 800 and 1100 MHz for general communications. In one embodiment, one or more of the radio frequency aspects of the system 100 use frequencies below 800 MHz for emergency or longer-range communication. In one embodiment, the frequency capabilities of the transceivers in the communication module 102 are adjustable, and the base unit 104 and communication module 102 select are configured to use communication frequencies that conserve power while still providing adequate communications reliability. In one embodiment, one or more of the radio frequency aspects of the system 100 use frequencies above 1100 MHz for relatively short-range communication (e.g. communication within a room). In one embodiment, the base unit 104 and/or one or more of the repeaters 113 includes a direction finding antenna for determining a direction of the radiation received from the communication module 102. In one embodiment, the base unit 104 and/or one or more of the repeaters 113 includes an adaptive antenna for increasing antenna gain in the direction of the communication module 102. In one embodiment, the base unit 104 and/or one or more of the repeaters 113 includes an adaptive antenna for canceling interfering noise.

In one embodiment, the communication module 102 includes radio frequency, acoustic and infrared communications capabilities. In one embodiment, the system 100 communicates with the communication module 102 using radio frequency, acoustic or infrared communication depending on the situation, e.g., acoustic, infrared, or relatively higher frequency radio frequencies for relatively shorter range communication and relatively lower frequency radio frequencies for relatively longer range communications.

Although various embodiments have been described above, other embodiments will be within the skill of one of ordinary skill in the art. Thus, although described in terms of a blind user, such description was for sake of convenience and not by way of limitation. The invention is limited only by the claims that follow.

What is claimed is:

1. A navigation system, comprising:
an RFID reader module; and
a communication module configured to communicate with said RFID reader module using wireless two-way handshaking communication, said communication module configured to use data from a plurality of RFID tags read by said RFID reader module and calculate a position of said RFID reader module among said plurality of RFID tags, said communication module configured to communicate said position to a user.

2. The system of claim 1, said communication module further comprising an acoustic input device.

3. The system of claim 1, said communication module further comprising an acoustic output device.

4. The system of claim 1, said communication module further comprising a vibrator device.

5. The system of claim 1, said communication module further comprising a keypad input device.

6. The system of claim 1, said communication module further comprising an infrared receiver.

7. The system of claim 1, said communication module further comprising an infrared transmitter.

8. The system of claim 1, said communication module further comprising a GPS receiver.

9. The system of claim 1, said communication module further comprising an inertial motion unit.

10. The system of claim 1, said communication module further comprising a 2-axis inertial motion unit.

11. The system of claim 1, said communication module further comprising a 3-axis inertial motion unit.

12. The system of claim 1, said communication module further comprising an accelerometer.

13. The system of claim 1, said communication module further comprising an RF location system.

14. The system of claim 1, said communication module further comprising an RFID tag reader.

15. The system of claim 1, said management system further comprising a an RFID tag configured to provide a description of said position for said user.

16. The system of claim 1, further comprising a video.

17. The system of claim 16, further comprising a facial recognition system.

18. The system of claim 1, said management system further comprising a video monitor

19. The system of claim 1, further comprising one or more repeaters.

20. The system of claim 1, further comprising one or more location system units disposed about an area.

21. The system of claim 20, wherein one or more of said location system units are configured to use infrared radiation for location and tracking of said communication module.

22. The system of claim 20, wherein one or more of said location system units are configured to use acoustic waves for location and tracking of said communication module.

23. The system of claim 20, wherein one or more of said location system units are configured to use electromagnetic waves for location and tracking of said communication module.

24. The system of claim 20, wherein one or more of said location system units further comprise motion detectors for a home security system.

25. The system of claim 1, wherein said communication device comprises a cellular telephone.

26. The system of claim 1, wherein said communication device comprises GPS receiver, said communication device configured to obtain location information from one or more location RFID tags when said RFID tag reader is within range to read location information from said one or more location RFID tags and said communication device configured to obtain location from said GPS receiver when location information is available from said GPS receiver.

27. The system of claim 1, wherein said communication device is configured to provide waypoint information to said user.

28. The system of claim 1, wherein said communication device is configured to provide GPS waypoint information to said user.

27. The system of claim 1, wherein said communication device is configured to provide RFID location tag waypoint information to said user.

29. The system of claim 1, wherein said communication device is configured to provide RFID location tag waypoint information to said user.

30. The system of claim 1, wherein said communication device is configured to receive waypoint information from a cellular telephone network.

31. The system of claim 1, wherein said communication device is configured to send location information using a cellular telephone network.

32. The system of claim 1, wherein said communication device is configured to receive building map information when the user enters a building.

33. The system of claim 1, wherein said communication device is configured to receive local area map information.

34. The system of claim 1, wherein said communication device is configured to store sidewalk map information for a selected area.

35. The system of claim 34, wherein said sidewalk map information comprises locations of potentially-dangerous locations such as street intersections.

36. The system of claim 34, wherein said sidewalk map information comprises locations of potentially-dangerous locations such as driveways.

37. The system of claim 34, wherein said sidewalk map information comprises locations of potentially-dangerous locations such as steps.

38. The system of claim 1, wherein said communication device is configured to track movements and compute a return path for the user to return to a specified starting point.

39. The system of claim 1, further comprising a second RFID reader module.

40. The system of claim 1, further comprising an inertial motion unit, said communication device configured to use location data and data from said inertial motion unit to determine which direction said user is facing.

41. The system of claim 1, further comprising an electronic compass.
